(19) United States
(12) Patent Application Publication
(10) Pub. No.: US 2025/0225059 A1
(43) Pub. Date: Jul. 10, 2025

(54) Generating Test Data Based On Actual Usage Data

(71) Applicant: Zoom Video Communications, Inc., San Jose, CA (US)

(72) Inventors: Dezhi Bi, Hangzhou (CN); Yuanyuan Du, Hangzhou (CN); Jingjin Xie, Hangzhou (CN); Xu Zhou, Hangzhou (CN)

(21) Appl. No.: 18/408,039

(22) Filed: Jan. 9, 2024

(51) Int. Cl. G06F 11/36

(52) U.S. Cl. CPC G06F 11/3684; G06F 11/3696; G06F 11/3698

(57) ABSTRACT

A test-case generation software receives requests that are to be processed by a request processing software. The test-case generation software obfuscates data in the requests to generate obfuscated request data. The test-case generation software generates test cases based on the obfuscated request data. The test-case generation software configures a testing tool based on the test cases. The test cases can be generated based on a distribution of endpoints identified in the requests. The test cases can be generated based on a distribution of values of a parameter in the requests.

### FIELD

This disclosure generally relates to system or software testing and, more specifically, to generating test data based on actual usage data of the system or software.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of a system for generating test data.

FIG. 5 is a block diagram of example functionality of a test case generation software.

FIG. 6A illustrates an example of a portion of a catalog of testing-relevant parameters.

FIG. 6B illustrates an example of a portion of a catalog of to-be-obfuscated parameters.

FIG. 6C illustrates an example of stored obfuscated requests.

FIG. 7A is a flowchart of an example of a technique for obfuscating request data.

FIG. 7B is a flowchart of an example of another technique for obfuscating request data.

FIG. 8 is a flowchart of an example of a technique for obfuscating parameter values included in requests.

### DETAILED DESCRIPTION

Practically all software, including without limitation conferencing software a unified communications as a service (UCaaS) platform, undergoes various testing phases throughout its lifecycle. Performance testing, including load and stress testing, aims to assess stability, reliability, and responsiveness to varying loads and stress conditions, ensuring optimal performance and identifying potential issues. Evaluating the effectiveness of a performance test involves considering the comprehensiveness of the test scenarios and the realism of test data. A successful performance test that simulates actual usage scenarios provides actionable insights, reveals potential issues, and contributes to improving system resilience and performance.

Several commercial and open-source tools (such as JMeter and Gatling) can be configured to execute performance test scenarios, collect results (e.g., performance results) of the test scenarios, and present the results (such as in the form or tabular data, graphical data, or the like) to stakeholders. A test scenario can include or can be composed of one or more test cases. Test scenarios provide a high-level context or situation for testing, and within each scenario, there can be multiple test cases. These test cases are specific and detailed instructions for testing individual aspects or functionalities within that scenario. A comprehensive performance test scenario encompasses parameterized data, performance test application programming interfaces (APIs) or application endpoints, the distribution of traffic among the performance test endpoints, performance test queries per second (QPS), and the duration of a performance test.

Creating effective and realistic simulation performance test scenarios presents challenges. For example, ensuring diversity and representation in the test cases is a common issue. When attempting to construct a performance test scenario manually, the risk of distortion is considerable. Common issues include inadequate diversity in the performance test data used and disparities in the distribution of traffic across endpoints (e.g., interfaces or APIs) of the application being tested. Manually crafted performance test cases often lack diversity in test data and traffic balance across interfaces, potentially distorting results and hiding system weaknesses.

A conventional common practice is to record and replay application traffic (e.g., actual usage data). That is, actual user requests are recorded and used as test cases in performance testing therewith simulating realistic stress test scenarios. However, such approaches violate privacy protection controls and policies that prohibit the recording, let alone the use, of user data.

Implementations of this disclosure address problems such as these by automatically generating test scenarios based on actual system traffic (e.g., requests from users). Test scenarios (e.g., test cases) are generated from obfuscated user requests. That is, rather than recording (e.g., storing) user requests, at least sensitive (e.g., personally identifiable information) user data in the user requests is obfuscated to generate obfuscated request data. Test scenarios and cases are generated based on the obfuscated request data. Data analysis techniques are applied to the obfuscated request data to identify statistically significant parameters and/or parameter values (or combinations thereof) for test scenario generation.

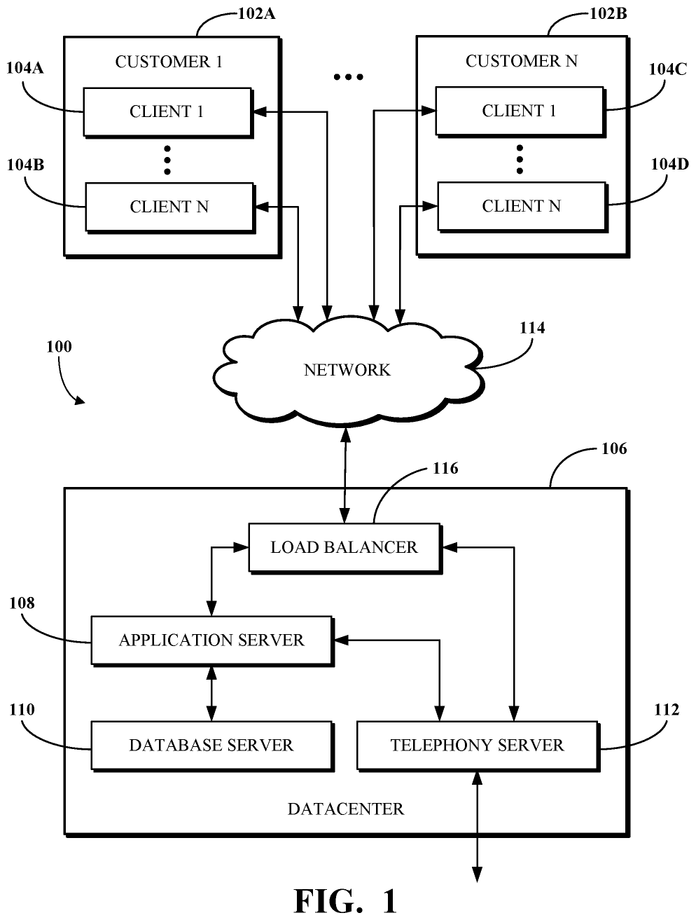

To describe some implementations in greater detail, reference is first made to examples of hardware and software structures used to implement a system for generating test data based on actual usage data. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

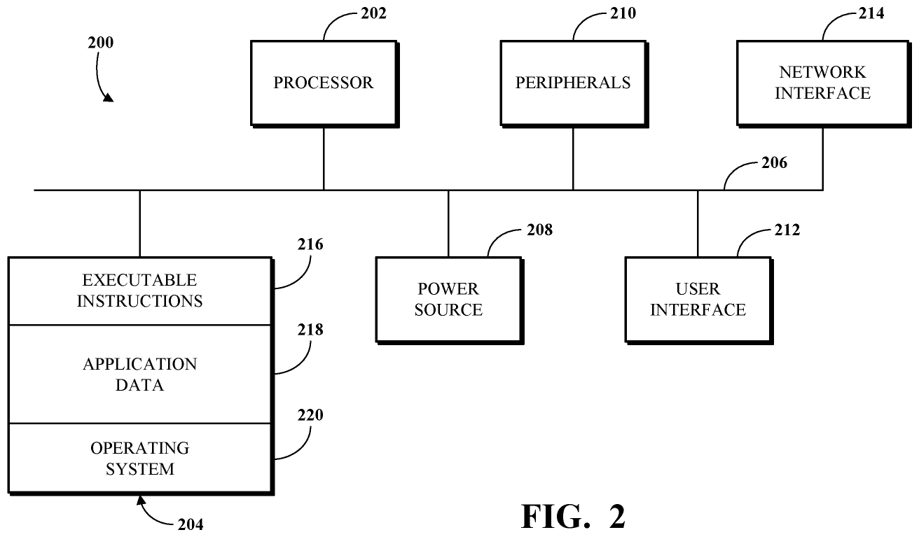

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

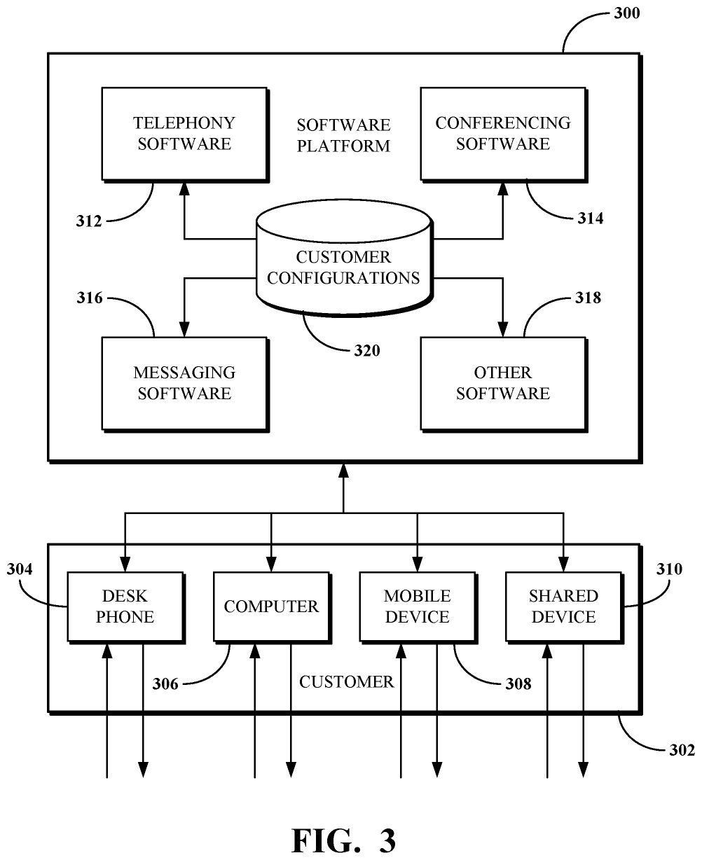

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call that is in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include a test case generation software usable for generating test data based on actual usage data.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

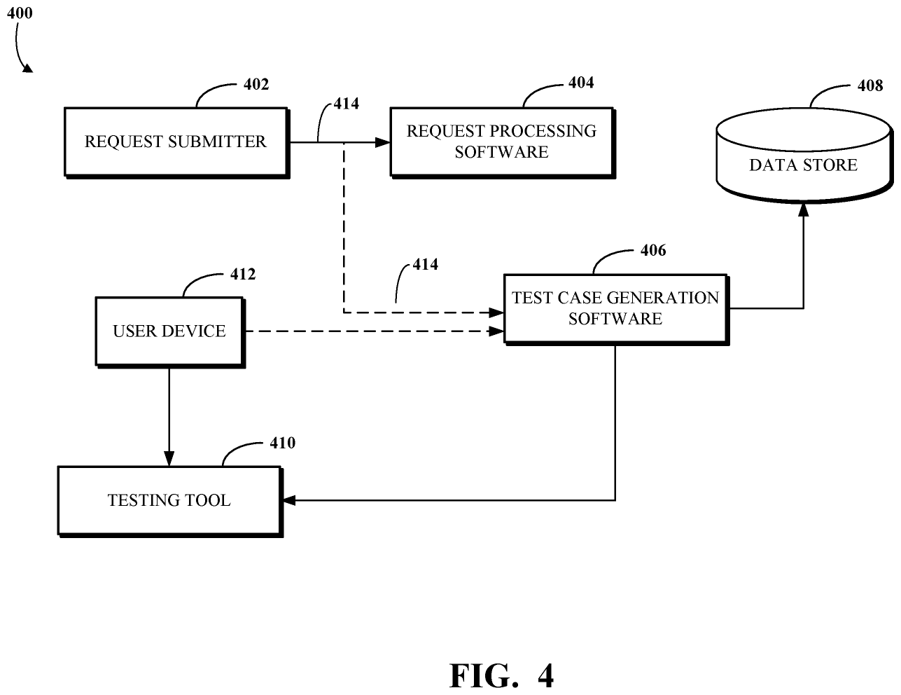

FIG. 4 is a block diagram of a system 400 for generating test data. The system 400 includes a request submitter 402, a request processing software 404, a test case generation software 406, a data store 408, a testing tool 410, and a user device 412. The request processing software 404 can be one or more software of the software platform 300 or some other software. The user device 412 can be a computing device that can be as described with respect to the computing device 200 of FIG. 2.

As can be appreciated, the request processing software 404 may receive requests from many request submitters, such as the request submitter 402. To illustrate, via user interfaces associated with the request processing software 404, a human user may cause a request to be submitted to the request processing software 404. As another illustration, a request submitter may be an automated process or system that programmatically submits requests to the request processing software 404, such as via APIs provided by the request processing software 404.

The request processing software 404 may provide a set of endpoints (e.g., ports or interfaces) through which request submitters can transmit their requests to the request processing software 404. To illustrate, and without limitations, the request processing software 404 may be the software platform 300 of FIG. 3 or the conferencing software 314 therein, and may provide endpoints including/join/meeting and/join/webinar that users (e.g., request submitters) can use to join a scheduled meeting and a scheduled webinar, respectively.

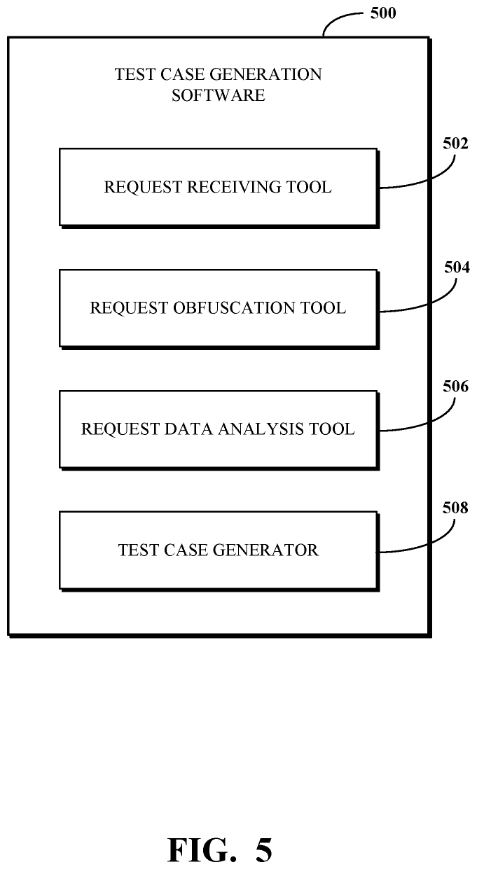

A request 414 received at an endpoint of the request processing software 404 can also be received at the test case generation software 406. The test case generation software 406 can receive the request 414 in any number of ways. For example, a webserver, a servlet engine, or the like (collectively, a webserver) that may initially receive the request 414 may be configured to transmit the request to both, the request processing software 404 and the test case generation software 406. A request receiving tool (such as a request receiving tool 502 described with respect to FIG. 5) of the test case generation software 406 may be implemented to work with the webserver to receive the request 414. The request receiving tool may be implemented as a plugin to the webserver. In another example, the request processing software 404 may include or work in conjunction with the request receiving tool. Other ways for the test case generation software 406 to receive the requests are possible. In an example, only requests received at certain identified endpoints of the request processing software 404 are forwarded to or otherwise received by the test case generation software 406.

The test case generation software 406 obfuscates the received requests to generate obfuscated request data therefrom and to store the obfuscated request data in the data store 408. Storing the obfuscated request data in the data store 408 can mean storing data of the obfuscated requests in any format that facilitates or enables data analysis. In an example, the obfuscated request data may be stored in a structured format, such as tabular data in a relational database. In another example, the obfuscated request data may be housed in a data lake that may be organized by endpoints, wherein each endpoint may correspond to a partition. To facilitate efficient data management and retrieval, the obfuscated request data can be further organized using Parquet files, allowing them to be stored and indexed based on various timeframes, such as daily, weekly, monthly, or another date-based categorization.

The test case generation software 406, and as further described with respect to FIG. 5, performs analysis on the obfuscated request data and generates test data (e.g., test cases) based on the analysis. The test cases may constitute or be included in a test scenario. The test case generation software 406 configures the testing tool 410 with the generated test cases and/or the test scenario. The testing tool 410 can be caused (e.g., triggered) to execute the test cases of the test scenario. For example, via the user device 412, a user may cause the test cases to be configured in the testing tool 410 and to cause the testing tool 410 to perform the test cases. The test case generation software 406 or the testing tool 410 may further provide user interfaces usable for viewing results of the execution of the test cases.

FIG. 5 is a block diagram of example functionality of a test case generation software 500, which may be, for example, the test case generation software 406 of FIG. 4. The test case generation software 500 includes tools, such as programs, subprograms, functions, routines, subroutines, operations, executable instructions, and/or the like for, inter alia and as further described below, generating test data. The test case generation software 500 generates test cases based on (but not using) at least certain actual usage data of a request processing software, such as the request processing software 404 of FIG. 4. The test case generation software 500 can be said to generate obfuscated (or anonymized) test cases based on actual usage of the request processing software.

At least some of the tools of the test case generation software 500 can be implemented as respective software programs that may be executed by one or more computing devices, such as the computing device 200 of FIG. 2. A software program can include machine-readable instructions that may be stored in a memory such as the memory 204, and that, when executed by a processor, such as processor 202, may cause the computing device to perform the instructions of the software program.

As shown, the test case generation software 500 includes a request receiving tool 502, a request obfuscation tool 504, a request data analysis tool 506, and a test case generator 508. In some implementations, the test case generation software 500 can include more or fewer tools. In some implementations, some of the tools may be combined, some of the tools may be split into more tools, or a combination thereof. Tools of the test case generation software 500 may be in whole or in part distributed and deployed at or within different components of the system 400 of FIG. 4. To illustrate, and as mentioned, the request receiving tool 502 may be included in a request processing software.

The request receiving tool 502 receives request data, as described above. The request data can be or include an endpoint and parameter values associated with parameters of the request. The request processing software may receive requests in any number of ways, including but not limited to Hypertext Transfer Protocol (HTTP) requests, WebSocket connections, and message queues. In the context of HTTP requests, the request receiving tool 502 can handle different request types such as GET, POST, PUT, and DELETE, each serving a specific purpose in client-server communication. In some cases, the request parameters may be included in or provided as a structure. To illustrate, at least some of the parameters (and their values) required by a request processor may be included in the request as a JavaScript Object Notation (JSON), an Extensible Markup Language (XML), a delimiter-separated list of values, or some other data structure.

Depending on a request type, the request receiving tool 502 may implement different techniques for extracting parameters and parameter values from the request. That is, the request receiving tool 502 can be configured to parse and interpret the received parameters and parameter values, regardless of the method used for submission. To illustrate, when handling HTTP GET requests, the parameters and their associated parameter values are typically included in the URL itself, following the endpoint. These parameters are appended to the URL after a question mark (“?”), and multiple parameters are separated by ampersands (“&”). For example, a GET request to join webinar may be https://example.com/join/webinar? userID=johnDoe&user_type=2&confID=42445. In contrast, HTTP POST requests may include parameters and their parameter values in the request body rather than the URL itself. This allows for the transmission of more complex data types, including JSON objects, XML data, binary data, or other types of data. To illustrate, and using the Java programming language as an example, a javax.servlet.http.HttpServletRequest object may be used to extract parameters and parameter values from a request.

The request obfuscation tool 504 is configured to receive incoming request data, subsequently obfuscating at least some of these data before storing the obfuscated request data for downstream processing activities, such as those performed by the request data analysis Tool 506. Thus, the request obfuscation tool 504 facilitates the analysis of the obfuscated request data, specifically for the generation of performance test cases. So that performance test cases accurately mimic real-world usage scenarios of the request processing software, it may be necessary to preserve certain request parameter values. To illustrate, the request processing software may be designed to execute different processing pathways based on the type of user making the request. This user type information may be encapsulated within or specified by a user_type parameter in requests. As such, so that performance test simulations are representative of actual usage of the request processing software, it may be necessary to include an accurate representation of the user_type data within the test cases.

To be clear, “obfuscated request data” means, at least, that the request data has been processed by the request obfuscation tool 504 to being stored. As such, the obfuscated request data may include original parameter values and obfuscated parameter values. The request obfuscation tool 504 may determine that none of the parameters of a request are to be obfuscated. Accordingly, the obfuscated request data (e.g., what the request obfuscation tool 504 stores) would not, in such a case, include any obfuscated parameter values.

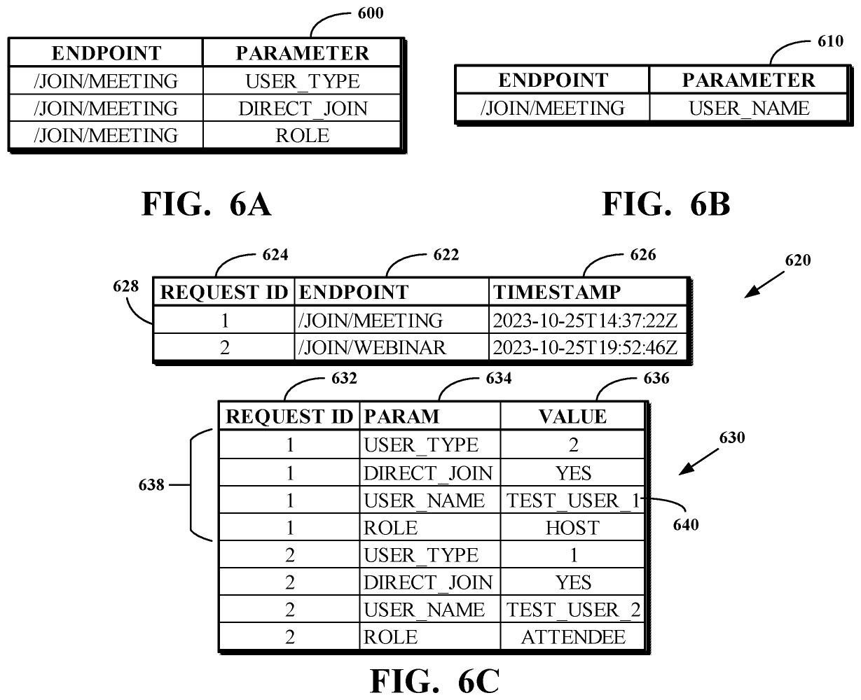

The request obfuscation tool 504 may include or have access to, a catalog of parameters deemed relevant for testing (“testing-relevant parameters”), which can be as illustrated with respect to FIG. 6A. A “testing-relevant parameter” is defined as a parameter whose values are to be preserved during the obfuscation process, as these preserved values are subsequently utilized in the generation of performance test cases. The catalog of testing-relevant parameters may be stored in a data store, such as the data store 408 of FIG. 4. The testing-relevant parameters (i.e., values therefor) are analyzed for the purpose of generating test cases.

The testing-relevant parameters can be identified in any number of ways. For example, testing-relevant parameters may be specified based on input from software developers who have knowledge of the architecture and performance bottlenecks of the request processing software. For example, testing-relevant parameters may be identified based on root cause analyses of performance issues. As another example, machine learning algorithms can be utilized to analyze historical performance data and automatically identify parameters that are statistically significant in affecting performance. Furthermore, customer feedback and incident reports may also be used in identifying parameters that are at least relevant for realistic and effective performance testing.

The request obfuscation tool 504 may include or have access to a catalog of parameters to be obfuscated (“to-be-obfuscated parameters”), which can be as illustrated with respect to FIG. 6B. A “to-be-obfuscated parameter” is defined as a parameter whose value is sensitive and/or non-essential for performance testing and, therefore, should be altered or masked to ensure data privacy and security. For example, a to-be-obfuscated parameter may include personally identifiable information (PIIs) of users, such as user names, passwords, and email addresses. More broadly, a “to-be-obfuscated parameter” can be any parameter whose value is to be obfuscated to adhere to regulatory compliance requirements, to company specific policies and procedures regarding data privacy, to adhere to input from data security teams, and the like.

FIG. 6A illustrates an example of a portion 600 of a catalog of testing-relevant parameters. As mentioned, the catalog of testing-relevant parameters may be stored in a data store, such as the data store 408 of FIG. 4. While the portion 600 is shown in a tabular format, the catalog of testing-relevant parameters may be stored in any suitable format or data structure.

The catalog of testing-relevant parameters may include, per endpoint, the names of the parameters that are relevant to testing. To illustrate, the requests to the endpoint/join/meeting may include the parameters user_type (e.g., specifying whether the user is a paying user), direct_join (e.g., indicating whether users can bypass a waiting room), role (e.g., specifying whether the participant is, for example, a host or an attendee), user_name, pass_code (e.g., indicating an encrypted or plain-text passcode for entering the meeting), audio_state (e.g., specifying whether users are to be joined to the meeting with audio enabled or disabled), and video_state (e.g., specifying whether users are to be joined to a meeting with video enabled or disabled). The portion 600 indicates that only the parameters user_type, direct_join, and role are relevant to testing (i.e., are testing-relevant parameters). As such the values of these parameters are not to be obfuscated and the values of at least some other parameters may be obfuscated. It is noted that the disclosure herein is not limited to or by any particular parameters, parameter values, or parameter semantics.

While the portion 600 indicates (includes) parameter names (e.g., ‘USER_TYPE,” “DIRECT_JOIN,” and “ROLE”), other or additional ways of indicating testing-relevant parameters are possible. For example, in scenarios where specific types of requests do not include parameter names, the testing-relevant parameters may be identified based on their positional order within the request data structure (e.g., positions 1, 2, and 4). This positional approach can be useful with respect to requests that employ non-key-value pair data structures.

FIG. 6B illustrates an example of a portion 610 of a catalog of to-be-obfuscated parameters. The catalog of to-be-obfuscated parameters may be stored in a data store, such as the data store 408 of FIG. 4. The portion 610 illustrates that the value of the user_name parameter is to be obfuscated.

Referring again to FIG. 5, obfuscating a parameter value can mean or include transforming the original value in a way that obscures the original value, making it impossible to trace back to the original value. Any number of obfuscation techniques are possible. In an example, hashing can be performed. As is known, hashing is a one-way function that takes an input value (e.g., string) and produces another value (e.g., a string of characters, which is typically a digest that represents the string). Hashing is irreversible, which means that the original value cannot be guessed or retrieved back from the hash. In another example, the to-be-obfuscated values can be replaced with random values.

In another example, a catalogue of test values may be randomly used in place of the real values. To illustrate, and without limitations, the catalogue of replacement values may include the values test_user_1, test_user_2, and test_user_3 for the parameter user_name and a received request may include user_name=FrodoBaggins. As user_name is a to-be-obfuscated parameter (based on the portion 610 of FIG. 6B), one of the values may be randomly selected from the catalogue of replacement values to obfuscate the actual user_name (e.g., FrodoBaggins). An obfuscated value 640 in the second data structure 630 of FIG. 6C, illustrates that the test value “test_user_1” is randomly selected to replace the actual user_name value (e.g., FrodoBaggins).

The catalogue of replacement values may include grouped sets of test values that are designed to be used in conjunction with one another. For example, a set may include test_user_1 for the user_name parameter, test_email_1@example.com for the email parameter, and password1 for the password parameter. Such grouped sets ensure that the obfuscated data maintains a level of consistency and coherence, which is particularly important for testing scenarios that rely on the interrelation of multiple parameters.

The catalogue of replacement values is not limited to simple replacements and can include complex data structures or dynamic values generated at runtime. For instance, the catalogue of replacement values can include JSON objects or XML elements to replace nested or hierarchical data within the requests.

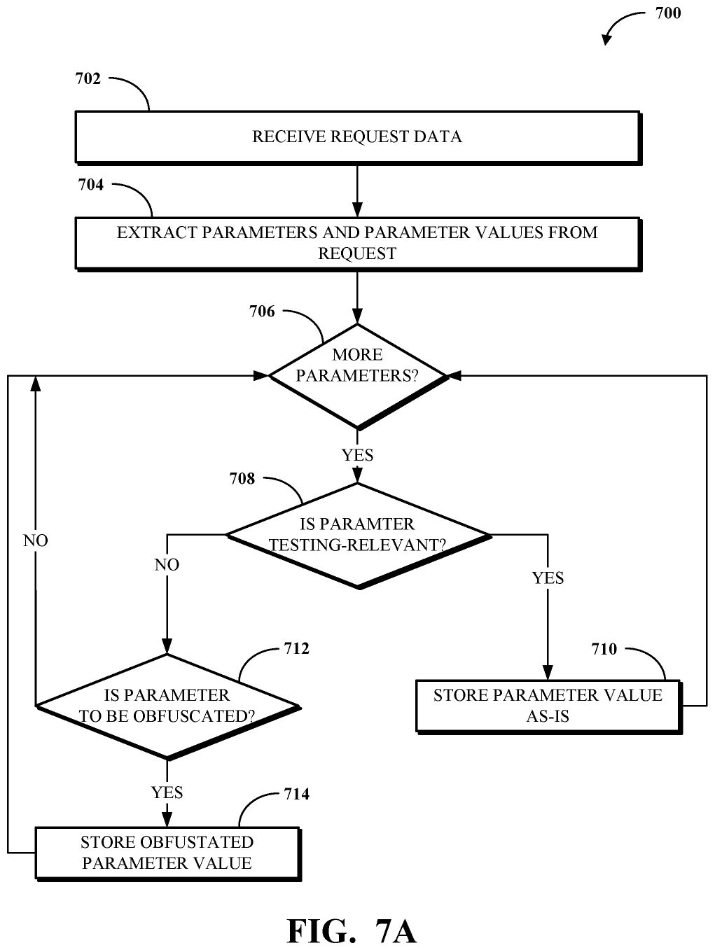

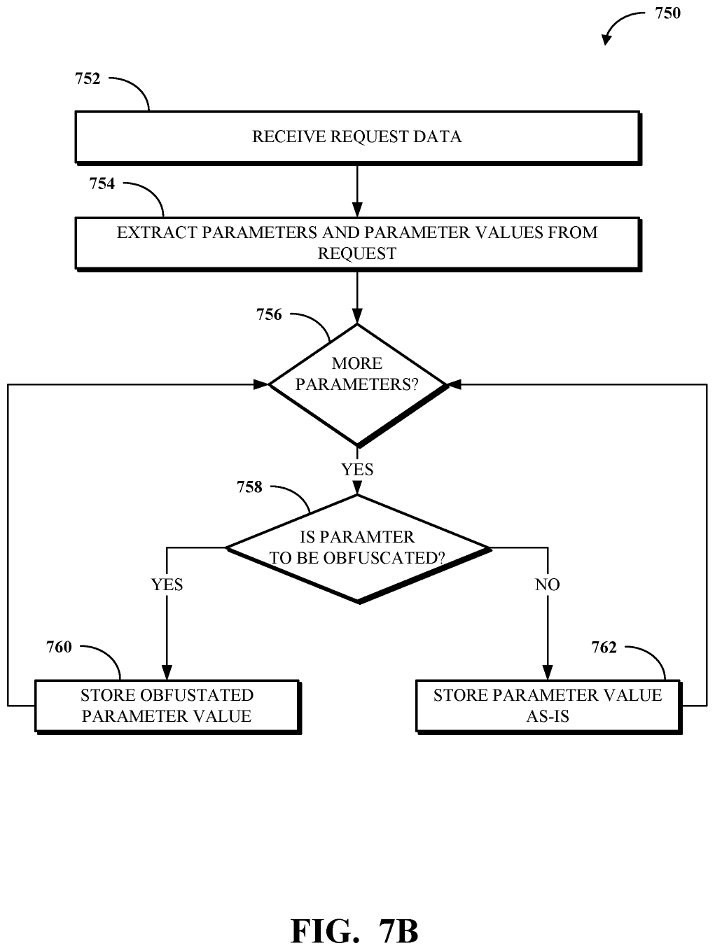

As mentioned, certain parameters may be designated as testing-relevant parameters and certain other parameters may be designated as to-be-obfuscated parameters. As such, there can be undesignated parameters. In an example, the undesignated parameters may also be obfuscated. As such, unless a parameter is designated as being testing relevant, the parameter value will be obfuscated. In another example, the undesignated parameters may not be obfuscated. In yet another example, and as described with respect to FIG. 7A, undesignated parameters are not saved. That is, undesignated parameters are ignored by the request obfuscation tool 504.

In yet another example, the request obfuscation tool 504 may only include a catalogue of to-be-obfuscated parameters. As such, only such parameters are obfuscated, and all other request parameter values are not obfuscated. That is, and as further described with respect to FIG. 7B, unless a parameter is designated as a to-be-obfuscated parameter, the value of the parameter is stored as-is. In this case, any parameter that is not a to-be-obfuscated parameter can be analyzed by request obfuscation tool 504 to generate test cases.

The request obfuscation tool 504 stores the obfuscated request data in a data store, such as the data store 408 of FIG. 4. FIG. 6C illustrates an example of stored obfuscated requests. While certain data arrangement and data structures are illustrated in FIG. 6C, the disclosure is not so limited and any way of storing the obfuscated requests is possible. For example, and as mentioned above, the stored obfuscated requests may be stored in a data lake.

A first data structure 620 may include data relating to the endpoints (as shown in a column 622) at which requests were received by the request processing software. Each received request may be assigned an identifier (as shown in a column 624) and the timestamps (as shown in a column 626) at which the requests were received are also included in the first data structure 620. A second data structure 630 includes the obfuscated request data. For each of the requests of the first data structure 620, a set of entries are included in the second data structure 630. A column 632 corresponds to the request identifier of the first data structure 620 that the entry corresponds to; a column 634 includes a parameter name, and a column 636 includes a parameter value (which may be obfuscated). For example, a set of entries 638 includes request parameters and corresponding (obfuscated) parameter values associated with a request 628.

The request data analysis tool 506 performs analysis on the stored request data to derive statistics or, more broadly, to derive usage patterns. The usage patterns can include endpoint usage patterns (e.g., statistics) and parameter value patterns (e.g., statistics). The request data analysis tool 506 may use or apply any data analysis techniques, including but not limited to statistical analysis, machine learning algorithms, or pattern recognition.

To illustrate, the statistics may include that, within a particular timeframe, the endpoint/join/meeting was called (e.g., requested) 100 times; that in 80 of those times the parameter user_type had a value of 1 and in 20 of those times the parameter user_type had value of 2; that the endpoint/join/webinar was requested 100 times; that in 70 of those times, the user_type parameter had a value of 1; that in 20 of those times, the user_type parameter had a value of 2; and that in the remaining 10 times, the user_type parameter was not provided. As another illustration, by performing endpoint analysis, the request data analysis tool 506 may determine, for example, that the endpoint/join/meeting accounts for half of the requests to the request processing software; and that other endpoint (e.g., /getipinfo, /im/account/groups, and other interfaces) account for less than 1% of the total requests.

The request data analysis tool 506 may identify relative frequencies of the different endpoints (i.e., of requests to the endpoints) within particular (e.g., given) timeframes. To illustrate, the request data analysis tool 506 may identify that, on average, between 12:00 PM and 5:00 PM EST, 78% of the requests are to the endpoint/join/meeting, 11% of the requests are to the endpoint/join/webinar, 9% of the requests are to the endpoint/meeting/create, and 2% are to the endpoint/profile/update.

The request data analysis tool 506 may perform parameter analysis. Certain endpoints (e.g., application code or logic associated therewith) may be sensitive to (e.g., perform differently based on) the parameter and proportions of the parameters, which can exert varying levels of stress on the request processing software due to differing underlying logics. To address the issue of parameter simulation, the request data analysis tool 506 may calculate ratios between different parameters as well as ratios between various values of the same parameter for each endpoint. To illustrate, when considering the/join/meeting endpoint, the request processing software may experience different levels of performance profile depending on whether 10 or 1000 users are joining a meeting. Furthermore, processing performance may vary significantly based on the type of user involved (i.e., the value of the parameter user_type), such as whether the user is paying versus a free user. As such, data simulation resulting from the data analysis would focus on two dimensions: the ratio between disparate data sets (e.g., user to meeting) and the ratio between different attributes within the same data set (e.g., paid users versus free users). The request data analysis tool 506 may identify frequent combinations (co-occurrences) of parameter values within the stored obfuscated requests. To illustrate, the request data analysis tool 506 may determine that, with respect to the/join/meeting endpoint, the combination of parameter values user_type=1 and direct_join=Yes occurs 80% of the time.

The request data analysis tool 506 may determine whether a parameter is statistically significant. For example, if the request data includes too many distinct values for a certain parameter, then that parameter may not be statistically significant for generating test cases. That is, no test cases that are specifically directed (or designed) to test the impact of different values of this parameter on performance would be generated. Techniques such as hypothesis testing, chi-squared tests, or Bayesian analysis, may be used to evaluate whether the distribution of parameter values of a parameter is statistically significant.

In an example, a simple comparison of the unique parameter values to the total number of requests can indicate whether the parameter is statistically significant. To illustrate, if the parameter “title” in the endpoint/create/meeting has 943 unique values out of 1000 total requests, the request data analysis tool 506 may determine that this parameter is not statistically significant for performance testing. On the other hand, if a parameter such as meeting_type has only 3 unique values appearing in varying frequencies across 1000 requests, then meeting_type can be determined to be statistically significant.

The test case generator 508 generates test cases based on the analysis performed by the request data analysis tool 506. In an example, the test case generator 508 may present test scenarios, including test cases in user interfaces associated with the test case generation software 500. Testing or quality assurance engineers may use the presented test scenarios to configure a testing tool, such as the testing tool 410 of FIG. 4. In an example, the test case generator 508 may programmatically configure the testing tool via APIs provided by the testing tool. Configuring the testing tool may include writing test scenario configuration files. The test scenario configuration files generated by the test case generator 508 serve as a blueprint for executing specific test cases within the testing tool. Configuration files may be in various formats, such as XML, JSON, or some other structured and/or proprietary format of the testing tool. Configuration files may be imported into the testing tool for execution. The testing tool then interprets these files to carry out the specified test scenarios, collecting data on response times, success rates, and other relevant metrics.

To illustrate, the test case generator 508 may configure the testing tool (e.g., generate one or more configuration files for the testing tool) instructing the testing tool 410 to perform the following tasks within a 20-second window: submit 93 requests to the endpoint/join/webinar, 7 requests to the endpoint/join/webinar, and 3 requests to the endpoint/profile/update. Additionally, 90% of the requests to/join/webinar may include the parameters user_type=1 and direct_join=yes.

Some parameters may be required by, or may optionally be added to, requests to certain endpoints. However, such parameters may not be specifically indicated as testing-relevant parameters or may not be identified as statistically significant for testing. Values for such parameters may be randomly selected from the obfuscated request data.

The output of testing tool may be presented in various formats such as tables, graphs, and log files. Table I illustrates a simplified example of a summary output report generated by the testing tool subsequent to executing a configured test scenario. Table I is a mere illustration and the disclosure herein is not limited by or to the contents of Table I. In Table I, Label may indicate the name of an endpoint; Samples may indicate the number of samples (e.g., HTTP requests) executed; Average may indicate the average response time in milliseconds; Min may indicate the minimum response time in milliseconds; Max may indicate the maximum response time in milliseconds; Std. Dev. may indicate the standard deviation of the response time; Error % may indicate a percentage of requests that resulted in errors; and Throughput may indicate the number of requests per second processed by the request processing software.

TABLE I

| Label | Samples | AVG | Min | Max | Std. Dev. | Error % | Throughput |
|---|---|---|---|---|---|---|---|
| /join/meeting | 1000 | 120 | 100 | 150 | 15 | 1.0% | 50.0 |
| TOTAL | 1000 | 120 | 100 | 150 | 15 | 1.0% | 50.0 |

To further describe some implementations in greater detail, reference is next made to examples of techniques which may be performed by or using a system for generating test data based on actual usage data. FIG. 7A is a flowchart of an example of a technique 700 for obfuscating request data. The technique 700 can be executed using computing devices, such as the systems, hardware, and software described with respect to FIGS. 1-6C. The technique 700 can be performed, for example, by executing a machine-readable program or other computer-executable instructions, such as routines, instructions, programs, or other code. The steps, or operations, of the technique 700, or another technique, method, process, or algorithm described in connection with the implementations disclosed herein can be implemented directly in hardware, firmware, software executed by hardware, circuitry, or a combination thereof. The steps of the technique 700 can be distributed (e.g., performed) using multiple processors, memories, or both. The technique 700 can be implemented at least in part by a request obfuscation tool, such as the request obfuscation tool 504 of FIG. 5.

At 702, request data are received. The request data can be received as described with respect to the request receiving tool 502 of FIG. 5. As such, in an example, the request itself is received. At 704, the request data are extracted from the request. The request data can be or include the request endpoint, the parameters, and the parameter values included in the request.

For each of the parameters, the techniques 700 performs the steps 708 and 710 or performs the steps 708, 712, and 714. As such, at 706, the technique 700 determines whether there are more parameters to process. If there are more parameters to process, the technique 700 proceeds to 708 to process a next parameter; otherwise, the technique 700 terminates (not shown). At 708, the technique 700 determines whether the next parameter is relevant to testing. In an example, the technique 700 determines whether the parameter (e.g., the name or position of the parameter) is included in a catalogue of testing-relevant parameters. If the parameter is a testing-relevant parameter, the technique 700 proceeds to 710; otherwise, the technique 700 proceeds to 712.

At 710, the value of the parameter, as received in the request, is stored, such as described above. At 712, the technique 700 determines whether the parameter is a to-be-obfuscated parameter. Determining whether the parameter is to be obfuscated can be based on determining whether the parameter is included in a catalogue of to-be-obfuscated parameters. If the parameter is to be obfuscated, the technique 700 proceeds to 714. At 714, an obfuscated value of the parameter can be obtained for storage. In an example, and as described above, obfuscating a parameter can include obtaining a replacement value from a catalogue of replacement values. From 710 or 714, as the case may be, the technique 700 proceeds back to 706. If, at 712, the technique 700 determines that the parameter is not to be obfuscated, then the parameter is essentially ignored (e.g., not written) and the technique 700 proceeds back to 706. As such, if a parameter is undesignated (as either testing-relevant or to-be-obfuscated), then the parameter value is ignored and not included in the obfuscated request data.

FIG. 7B is a flowchart of an example of a technique 750 for obfuscating request data. The technique 750 can be executed using computing devices, such as the systems, hardware, and software described with respect to FIGS. 1-6C. The technique 750 can be performed, for example, by executing a machine-readable program or other computer-executable instructions, such as routines, instructions, programs, or other code. The steps, or operations, of the technique 750, or another technique, method, process, or algorithm described in connection with the implementations disclosed herein can be implemented directly in hardware, firmware, software executed by hardware, circuitry, or a combination thereof. The steps of the technique 750 can be distributed (e.g., performed) using multiple processors, memories, or both. The technique 750 can be implemented at least in part by a request obfuscation tool, such as the request obfuscation tool 504 of FIG. 5.

Steps 752-756 of the technique 750 can be similar to steps 702-706 of the technique 7A and descriptions therefor are omitted. At 758, which can similar to the step 712 of FIG. 7A, the technique 750 determines whether a parameter is to be obfuscated. More specifically, the technique 750 determines whether the value of parameter is to be obfuscated. To determine whether the value of the parameter is to be obfuscated, the technique 750 may look up the parameter (e.g., the parameter name) in a catalogue of to-be-obfuscated parameters. If the catalogue includes the parameter, then the parameter value is to be obfuscated. If the technique 750 determines that the parameter is to be obfuscated, then the technique 750 proceeds to 760; otherwise, the technique 750 proceeds to 762.

At 760, the technique 750 stores an obfuscated value for the parameter. Storing the obfuscated value can be as described with respect to 714 of FIG. 7A. In an example, and as described above, obfuscating a parameter can include obtaining a replacement value from a catalogue of replacement values. At 762, the value of the parameter, as received in the request, is stored, such as described above. From 760 or 762, as the case may be, the technique 750 proceeds back to 756.

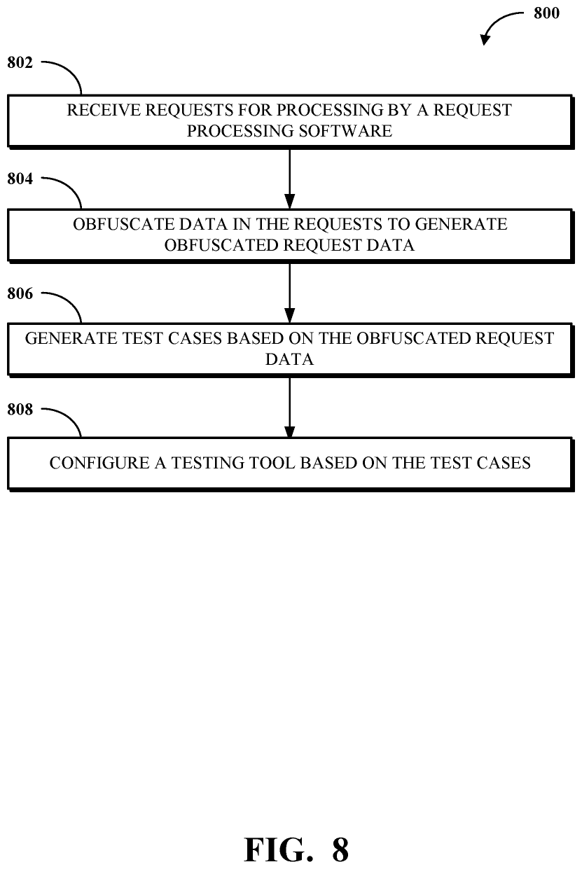

FIG. 8 is a flowchart of an example of a technique 800 for obfuscating parameter values included in requests. The technique 800 can be executed using computing devices, such as the systems, hardware, and software described with respect to FIGS. 1-6C. The technique 800 can be performed, for example, by executing a machine-readable program or other computer-executable instructions, such as routines, instructions, programs, or other code. The steps, or operations, of the technique 800, or another technique, method, process, or algorithm described in connection with the implementations disclosed herein can be implemented directly in hardware, firmware, software executed by hardware, circuitry, or a combination thereof. The steps of the technique 800 can be distributed (e.g., performed) using multiple processors, memories, or both. The technique 800 can be implemented at least in part by test case generation software, such as the test case generation software 406 of FIG. 4 or the test case generation software 500 of FIG. 5.

At 802, the test-case generation software receives requests for processing by a request processing software, which can be the request processing software 404 of FIG. 4. As described above, the requests received by the request processing software can also be forwarded by the test case generation software. The test case generation software can receive the requests as described above. Receiving a request can include receiving request data or extracting the request data from the request. The request data can include an endpoint, parameters (e.g., parameter names), and parameter values of the parameters.

At 804, the test case generation software obfuscates data in the requests to generate obfuscated request data. Obfuscating the request data can include determining whether to obfuscate any of the request data. For example, the technique 800 may determine, for each parameter of the request, whether to obfuscate the parameter or not, as described above. As such, the test case generation software may obfuscate zero or more of the request parameters.

The test case generation software may replace at least some parameter values in the requests with respective hashed values. The test case generation software may replace at least some parameter values in the requests with respective replacement values obtained from a catalogue of replacement values. The test case generation software may obfuscate a parameter value of a parameter responsive to a determination that the parameter is not significant to testing. The test case generation software may determine not to obfuscate a parameter value of a parameter responsive to a determination that the parameter is significant to testing.

At 806, the test case generation software generates test cases based on the obfuscated request data. The test case generation software generates (e.g., automatically generates) the test cases based on an analysis of the obfuscated request data as described with respect to the request data analysis tool 506 of FIG. 5. The test cases can be automatically generated based on a statistical analysis of the obfuscated request data.

The test case generation software can generate the test cases based on a distribution of endpoints identified in the requests. The test case generation software can generate the test cases based on a distribution of values of a parameter in the requests. The test case generation software can generate the test cases by identifying a combination of parameter values that co-occurs together and configuring at least a subset of the test cases based on the combination of the parameter values. The test case generation software can generate the test cases by evaluating whether a parameter value of a parameter in the requests is statistically significant and using one of the parameter value or a random value to generate test cases that include the parameter based on whether the parameter is statistically significant.

At 808, the test case generation software configures a testing tool based on (e.g., with) the test cases. For example, the testing tool may be automatically configured or caused to automatically execute the test cases.

In an example, the technique 800 may provide a user interface for displaying results of an execution of the test cases via the testing tool. In an example, the technique 800 may receive the testing results from the testing tool and cause the results to be displayed, such as at a display of a client device, which can be the user device 412 of FIG. 4.

For simplicity of explanation, the techniques 700, 750, and 800 of FIGS. 7A, 7B, and 8, respectively, are each depicted and described herein as a respective series of steps or operations. However, the steps or operations of each of these techniques in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The disclosure presented herein may be considered in view of the following clauses.

Example Clause A: A method, that includes receiving, by test-case generation software, requests for processing by a request processing software; obfuscating, by the test-case generation software, data in the requests to generate obfuscated request data; generating, by the test-case generation software, test cases based on the obfuscated request data; and configuring, by the test-case generation software, a testing tool based on the test cases.

Example Clause B: The method of Example Clause A, where generating, by the test-case generation software, the test cases based on the obfuscated request data includes: generating the test cases based on a distribution of endpoints identified in the requests.

Example Clause C: The method of Example Clause A or Example Clause B, where generating, by the test-case generation software, the test cases based on the obfuscated request data includes: generating the test cases based on a distribution of values of a parameter in the requests.

Example Clause D: The method of any one of Example Clauses A-C, where generating, by the test-case generation software, the test cases based on the obfuscated request data includes: identifying a combination of parameter values that co-occurs together; and configuring at least a subset of the test cases based on the combination of the parameter values.

Example Clause E: The method of any one of Example Clauses A-D, where generating, by the test-case generation software, the test cases based on the obfuscated request data includes: evaluating whether a parameter value of a parameter in the requests is statistically significant; and using one of the parameter value or a random value to generate test cases that include the parameter based on whether the parameter is statistically significant.

Example Clause F: The method of any one of Example Clauses A-E, further including: displaying results of an execution of the test cases via a user interface of the testing tool.

Example Clause G: A system that includes one or more memories; and one or more processors. The one or more processors is configured to execute instructions stored in the one or more memories to: receive, by test-case generation software, requests for processing by a request processing software; obfuscate, by the test-case generation software, data in the requests to generate obfuscated request data; generate, by the test-case generation software, test cases based on the obfuscated request data; and configure, by the test-case generation software, a testing tool based on the test cases.

Example Clause H: The system of Example Clause G, where to obfuscate, by the test-case generation software, the data in the requests to generate the obfuscated request data includes to: replace at least some parameter values in the requests with respective hashed values.

Example Clause I: The system of Example Clause G or Example Clause H, where to obfuscate, by the test-case generation software, the data in the requests to generate the obfuscated request data includes to: replace at least some parameter values in the requests with respective replacement data obtained from a catalogue of replacement values.

Example Clause J: The system of any one of Example Clauses G-I, where to obfuscate, by the test-case generation software, the data in the requests to generate the obfuscated request data includes to: obfuscate a parameter value of a parameter responsive to a determination that the parameter is not significant to testing.

Example Clause K: The system of any one of Example Clauses G-J, where to obfuscate, by the test-case generation software, the data in the requests to generate the obfuscated request data includes to: determine not to obfuscate a parameter value of a parameter responsive to a determination that the parameter is significant to testing.

Example Clause L: The system of any one of Example Clauses G-K, where to obfuscate, by the test-case generation software, the data in the requests to generate the obfuscated request data includes to: identify a parameter in a request of the requests; determine whether an obfuscation catalog includes the parameter; and in response to determining that that the obfuscation catalog includes the parameter, replace a value of the parameter with a random value in the obfuscated request data.

Example Clause M: The system of any one of Example Clauses G-L, where the test cases are based on a distribution of endpoints identified in the requests.

Example Clause N: The system of any one of Example Clauses G-M, where the test cases are based on a distribution of values of a parameter in the requests.

Example Clause O: The system of any one of Example Clauses G-N, where the test cases are based on a co-occurring parameter values in the requests.

Example Clause P: Non-transitory computer readable media storing instructions operable to cause one or more processors to perform operations including: receiving, by test-case generation software, requests for processing by a request processing software; obfuscating, by the test-case generation software, data in the requests to generate obfuscated request data; generating, by the test-case generation software, test cases based on the obfuscated request data; and configuring, by the test-case generation software, a testing tool based on the test cases.

Example Clause Q: The non-transitory computer readable media of Example Clause P, where generating, by the test-case generation software, test cases based on the obfuscated request data includes: generating the test cases based on a statistical analysis of the obfuscated request data.

Example Clause R: The non-transitory computer readable media of Example Clause P or Example Clause Q, where obfuscating, by the test-case generation software, the data in the requests to generate the obfuscated request data includes: determining whether to obfuscate a parameter value of a parameter based on a lookup of the parameter in a catalogue of to-be-obfuscated parameters.

Example Clause S: The non-transitory computer readable media of any one of Example Clauses P-R, where obfuscating, by the test-case generation software, the data in the requests to generate the obfuscated request data includes: determining whether to obfuscate a parameter value of a parameter based on a lookup of the parameter in a catalogue of testing-significant parameters.

Example Clause T: The non-transitory computer readable media of any one of Example Clauses P-S, where obfuscating, by the test-case generation software, the data in the requests to generate the obfuscated request data includes: obfuscating a parameter value of a parameter based on a lookup of the parameter in a catalogue of replacement values.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by test-case generation software, requests for processing by a request processing software;
obfuscating, by the test-case generation software, data in the requests to generate obfuscated request data;
generating, by the test-case generation software, test cases based on the obfuscated request data; and
configuring, by the test-case generation software, a testing tool based on the test cases.

2. The method of claim 1, wherein generating, by the test-case generation software, the test cases based on the obfuscated request data comprises:
generating the test cases based on a distribution of endpoints identified in the requests.

3. The method of claim 1, wherein generating, by the test-case generation software, the test cases based on the obfuscated request data comprises:
generating the test cases based on a distribution of values of a parameter in the requests.

4. The method of claim 1, wherein generating, by the test-case generation software, the test cases based on the obfuscated request data comprises:
identifying a combination of parameter values that co-occurs together; and
configuring at least a subset of the test cases based on the combination of the parameter values.

5. The method of claim 1, wherein generating, by the test-case generation software, the test cases based on the obfuscated request data comprises:
evaluating whether a parameter value of a parameter in the requests is statistically significant; and
using one of the parameter value or a random value to generate test cases that include the parameter based on whether the parameter is statistically significant.

6. The method of claim 1, further comprising:
displaying results of an execution of the test cases via a user interface of the testing tool.

7. A system, comprising:
one or more memories; and
one or more processors, the one or more processors configured to execute instructions stored in the one or more memories to:
receive, by test-case generation software, requests for processing by a request processing software;
obfuscate, by the test-case generation software, data in the requests to generate obfuscated request data;
generate, by the test-case generation software, test cases based on the obfuscated request data; and
configure, by the test-case generation software, a testing tool based on the test cases.

8. The system of claim 7, wherein to obfuscate, by the test-case generation software, the data in the requests to generate the obfuscated request data comprises to:
replace at least some parameter values in the requests with respective hashed values.

9. The system of claim 7, wherein to obfuscate, by the test-case generation software, the data in the requests to generate the obfuscated request data comprises to:
replace at least some parameter values in the requests with respective replacement data obtained from a catalogue of replacement values.

10. The system of claim 7, wherein to obfuscate, by the test-case generation software, the data in the requests to generate the obfuscated request data comprises to:
obfuscate a parameter value of a parameter responsive to a determination that the parameter is not significant to testing.

11. The system of claim 7, wherein to obfuscate, by the test-case generation software, the data in the requests to generate the obfuscated request data comprises to:
determine not to obfuscate a parameter value of a parameter responsive to a determination that the parameter is significant to testing.

12. The system of claim 7, wherein to obfuscate, by the test-case generation software, the data in the requests to generate the obfuscated request data comprises to:
identify a parameter in a request of the requests;
determine whether an obfuscation catalog includes the parameter; and
in response to determining that that the obfuscation catalog includes the parameter, replace a value of the parameter with a random value in the obfuscated request data.

13. The system of claim 7, wherein the test cases are based on a distribution of endpoints identified in the requests.

14. The system of claim 7, wherein the test cases are based on a distribution of values of a parameter in the requests.

15. The system of claim 7, wherein the test cases are based on a co-occurring parameter values in the requests.

16. Non-transitory computer readable media storing instructions operable to cause one or more processors to perform operations comprising:
receiving, by test-case generation software, requests for processing by a request processing software;
obfuscating, by the test-case generation software, data in the requests to generate obfuscated request data;
generating, by the test-case generation software, test cases based on the obfuscated request data; and
configuring, by the test-case generation software, a testing tool based on the test cases.

17. The non-transitory computer readable media of claim 16, wherein generating, by the test-case generation software, test cases based on the obfuscated request data comprises:
generating the test cases based on a statistical analysis of the obfuscated request data.

18. The non-transitory computer readable media of claim 16, wherein obfuscating, by the test-case generation software, the data in the requests to generate the obfuscated request data comprises:
determining whether to obfuscate a parameter value of a parameter based on a lookup of the parameter in a catalogue of to-be-obfuscated parameters.

19. The non-transitory computer readable media of claim 16, wherein obfuscating, by the test-case generation software, the data in the requests to generate the obfuscated request data comprises:
determining whether to obfuscate a parameter value of a parameter based on a lookup of the parameter in a catalogue of testing-significant parameters.

20. The non-transitory computer readable media of claim 16, wherein obfuscating, by the test-case generation software, the data in the requests to generate the obfuscated request data comprises:
obfuscating a parameter value of a parameter based on a lookup of the parameter in a catalogue of replacement values.
